(19) United States
(12) Patent Application Publication
(10) Pub. No.: US 2014/0189478 A1
(43) Pub. Date: Jul. 3, 2014

(54) WEB BROWSERS FOR MOBILE AND SMALL SCREEN DEVICES

(71) Applicant: GAURAV BAZAZ, EDGEWATER, NJ (US)

(72) Inventor: GAURAV BAZAZ, EDGEWATER, NJ (US)

(21) Appl. No.: 14/142,743

(22) Filed: Dec. 27, 2013

Related U.S. Application Data
(60) Provisional application No. 61/747,068, filed on Dec. 28, 2012.

(51) Int. Cl. G06F 17/22; G06F 3/0482

(52) U.S. Cl. CPC G06F 17/2247; G06F 17/2235; G06F 3/0482
USPC 715/205; 715/234

(57) ABSTRACT

Innovations in the design and functionality of web browsers on mobile and other small screen devices and touchscreen devices are provided. A method is provided to extract relevant and/or actionable elements of a web page and make them easily accessible within a separate User Interface to the user so the user can quickly and easily carry relevant actions on the webpage. The method allows users to easily and productively access and work with webpages designed for larger screen devices within a small screen device.

### RELATED APPLICATION

This application claims the benefit of priority to U.S. Provisional Application 61/747,068 filed 28 Dec. 2012, the entire disclosure of which is incorporated by reference.

### FIELD OF THE INVENTION

The present invention relates to web browsers on small screen devices.

### BACKGROUND

Web browsers are software applications that are used to access web content on various electronic devices including smartphones and tablets. Most mobile devices provide a small screen on which the browser displays web content such as web pages. Also, given the limitations of processing power and network bandwidth, web pages tend to load on the browser slowly and may not display properly. In addition, navigating a web page that has not been optimized for mobile devices can be very cumbersome and difficult for a user as the information may not be clearly visible, might require many steps to discover and relevant actions such as clicking or submitting a form may be very inconvenient.

### SUMMARY OF INVENTION

The present invention proposes certain design, functional and processing innovations that can considerably improve the user experience with web browsers on mobile devices and generally for small screen devices. One of the major problems with web browsers on small screen devices is the fact that most web pages which have not been designed specifically for small screen devices tend to display very poorly on small screen devices. Some of the problems that are encountered include the following:
a. Text is too small
b. Links are not easily visible and very hard to click
c. Interactive elements such as animations and interactive menus do not process properly on small screen browsers or browsers on touch screen devices
d. Filling forms is very problematic as very small parts of the screen are visible
e. Clicking through to relevant information which is not on pages close to the homepages is hard as pages tend to load slowly given slow networks and even finding the right path is problematic because navigating individual screens and menus is troublesome

As described herein, a small screen device is defined as an electronic device that has a usable display screen small enough to make the device portable such as a smartphone, a standard cellphone, a tablet device or an electronic book reader. Examples of such devices include devices such as Apple's iPhone™, Apple's iPad™, Amazon's Kindle™, Microsoft Surface™ tablet, Samsung Galaxy™ phones, among others. The devices can use touchscreen input or keyboard inputs for user interaction.

As defined herein, a Web Browser is defined as a software application that users use to access content on the world wide web and other resources over the internet or other networks using standard protocol stacks such as TCP/IP/HTTP.

As used herein, an Information Element is defined as any piece of data or information such as text, images, videos, forms, tables or other such components of HTML markup, which form a coherent block of information and are intended to be associated with each other by the maker(s) of the web page. For instance the text information element would include all the text, separated into paragraphs and pages and passages as required, each forming a tree-structure information element with a parent information element and child information elements. Similarly, all images on the page will form one information element consisting of all images, but will branch into child information elements, where in each image within a group or in one section of the page forms a sub group of images, which in turn will branch into child information elements consisting of each individual image.

As used herein, a User Interface Element (UI Element) is a component of the user interface that is separate from other components but within the space occupied by the user interface. Specifically, it is a component of the User Interface (UI) that is rendered by the application, is visually contiguous or associatUl Elemented with the application and is separate from the web page itself.

The present invention proposes a model to solve various issues related to web browsers on small screen and touch screen devices. As described herein, a method is provided for making relevant information in a web page directly accessible to the user through a separate User Interface Element in the web browser.

When the user requests a new web page to be loaded, the browser requests the web page from a resource on the network where the document is located. The network resource returns the web page which is generally marked up (coded) in a language such as HTML (Hyper Text Markup Language). As the web page is returned a software component within the browsers or connected to the browsers scans the page and extracts relevant information from the page. The relevant information might be items such as:
a. major links
b. menu items
c. addresses
d. phone numbers
e. form elements
f. images
g. tables
h. videos and animations

This software component, Reorganizer System hereafter, uses built-in algorithms to identify different components of the web page based on their markup code, their location, the content of the elements and surrounding elements and other information criteria. The Reorganizer System may extract all or only some of the elements based on its settings which maybe hardcoded, user selected or dynamically set.

Once the components of the web page are identified, the Reorganizer System sorts them into relevant categories and labels them internally based on available descriptions. Once the Reorganizer System has completed the process of identifying and organizing the elements of the webpage, it makes them available under their respective categories in a separate User Interface element within the browser, referred to as the Scan Button. In most cases, the Reorganizer System will be a component of the web browser application itself. But it may also be running as a browser add-on, where it requests information from the browser and returns information to it, or runs as an application within the browser.

Once the Reorganizer system makes the relevant information available to the Scan Button, which shows as an element within the browser, the user can click this button to get the relevant information from the webpage without having to navigate the actual webpage. Under one embodiment, when the user clicks the Scan Button, the user can see a list of options which may include items such as:
a. Home
b. Menu
c. Address
d. Map
e. Phone
f. Videos
g. Images
h. Hours of operation
i. Information Tables
j. Forms

The list maybe displayed as a slide-out list, a dropdown, a popup or as any other workable user interface design.

The user can click one of these items to execute an action or see another list of options. For instance, if the user clicks the Address option, a new user interface element will display which displays the address(es) extracted from the webpage. Similarly, if the user clicks Menu, a list of links from the menu on the webpage, as extracted by the Reorganizer System, will be displayed in a new user interface element, from where the user can request other site pages by selecting one of the menu items. Again, if the user clicks the Phone option, the phone number(s) extracted from the page will be displayed with the option to place a call. If the images option is clicked, a new UI Element will be displayed with a gallery of images, possibly with captions or some surrounding text. If the user clicks the Information Tables option, a list of tables with tabular information extracted from the web page will be displayed. When the user selects a specific table from the list, the user may be navigated to that specific table on the web page or a new UI element may be displayed which displays the same information in a more user friendly format. When the Map option is clicked, the browser may open a new UI Element and display the address from the page on the map directly with option for directions. For the Videos option, when the user clicks, the browser may download the video and play it separately in a new UI Element rather than within the web page. When the user clicks the Forms button, a list of forms from the web page may be shown. If the user selects a particular form, he may be navigated to the form on the web page, or a new UI Element will be opened by the browser and the form displayed within that element. The form displayed within the browser opened UI Element may be reformatted to make it more user-friendly. For each option in the Scan Button, user may either be navigated to the corresponding element on the downloaded webpage or a new UI Element may be rendered by the browser within which the extracted information may be displayed. In case the information is displayed in a browser triggered UI Element, it may also be reformatted to a new more user friendly format.

The list of extracted items provided above is neither restrictive nor exhaustive, and is only indicative of possible models. Other additional information elements may also be extracted, while in some cases, fewer elements may be extracted and made available through the Scan Button. Similarly, the nature of operations available through the Scan Button may vary and be modified within the scope of the current invention.

In addition, the Reorganizer may be designed to download information about certain popular webpages beforehand, so that when the user downloads the given page, the Reorganizer populates the Scan Button directly, without scanning the web page, based on pre-downloaded data.

Additionally, the scan button may also acquire information elements from other pages on the website, not just the information elements on the given web page. This can be done in multiple ways. In one model the Reorganizer System (RS) may download the data about other pages directly from a network resource dedicated to serving the Reorganizer system, which may be provided by the entity providing the browser application. In another case, the RS may automatically download other pages of the site in the background without user requesting it, and scan the pages and make data from those pages also available. Additionally, the RS may store extracted information elements from the web site in cache or other on device storage, and retrieve the same information elements when the page or a page from the same site is accessed again by the user

Also, the entity that developed the webpage may add markup to their web pages specifically designed for the RS, which the RS will identify and read. Using this markup code from the web page, the RS will directly access the information elements of the web page, from within the page downloaded or from a different network source, and make it available under the Scan Button. The markup may include metadata for information elements within the given page, or across the site and may include paths for accessing the information within the web page or another network resource.

### DESCRIPTION OF DRAWINGS

FIG. 1 shows a mobile device 001 with control button 002. The device has a touchscreen interface 004 which is currently displaying a web browser application. The web browser application has a top menu bar 006 which includes an address box and displays the webpage 008 in the main middle section. It also has a bottom menu bar 010 which includes some symbols such as 012 for going back to the previous page and 013 which is the Scan button as described below.

FIG. 2 shows the same device with the Scan function executed. When the web browser application downloads a web page from the web or another source, the scan function reads all the elements of the page and indexes them according to their features. When the user clicks the Scan button 013, the menu 018 displays on the screen, displaying a list of all items that the scan function extracted from the web page. These are mostly relevant components of the page that the user may want to access, such as menus, contact information, addresses, phone numbers, photos, tables, forms etc. The menu graphic 018 has a header 015 which signifies the content of the graphical element. The graphical element 018, as shown has a list of items 016 extracted from the webpage that the user can directly access without having to browse through the page(s) of the site. Given the poor user experience associated with navigating pages on small screen devices such as cell phones, the present innovation allows user to get the information they want much faster, more easily and in a standardized model.

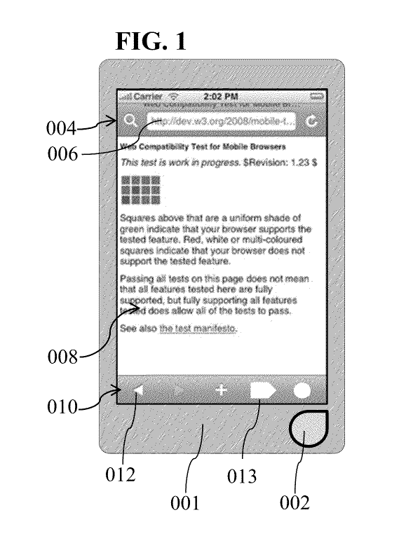

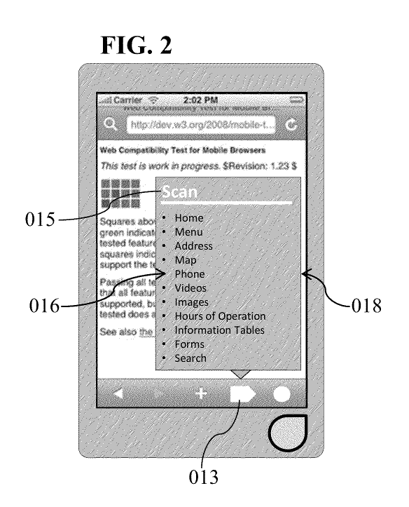

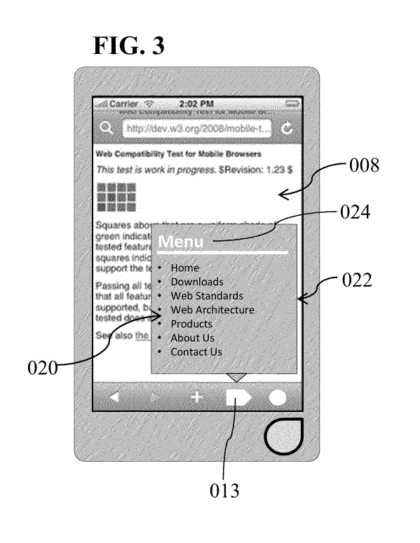

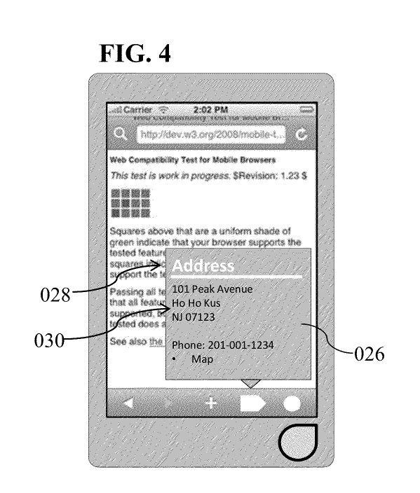

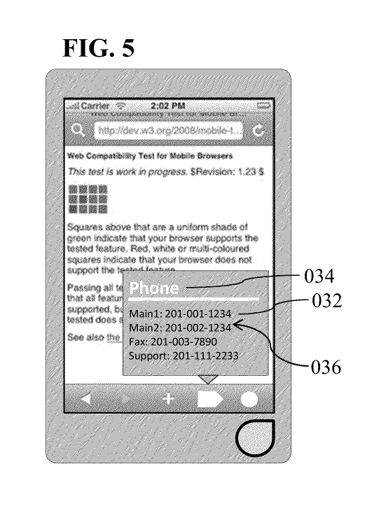

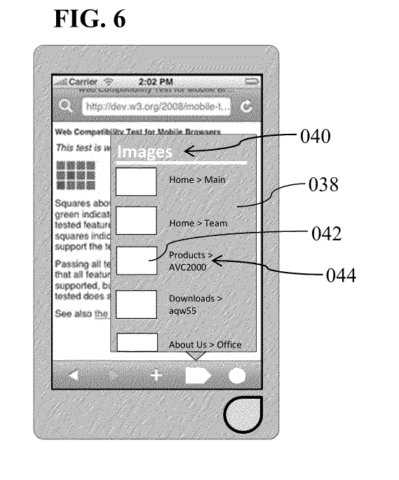

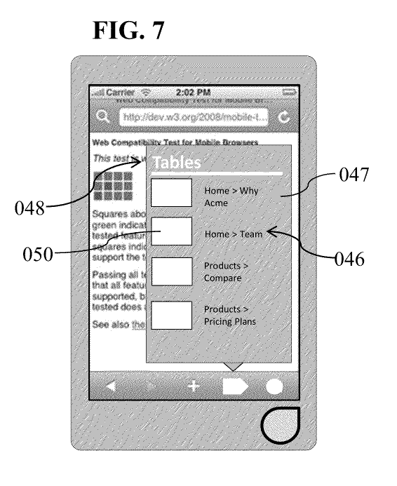

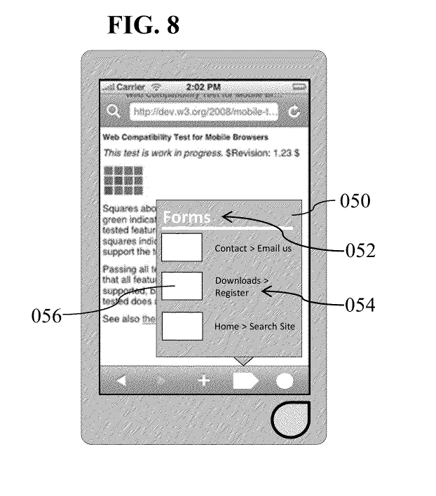

In FIG. 2, in graphical element 018, the user can select any of the menu items to get the item of information they wish to access. For instance the user can click the ‘Menu’ item to get a list of links that form the main navigational menu on the website as shown in FIG. 3. Most websites have a dynamic menu that doesn't render well and interacts poorly on mobile device browsers. Therefore, this model allows user to get access to the menu items in an easier to use model. When the user selects the ‘Menu’ item from the box 018 in FIG. 2, he gets the new box 022 of FIG. 3 which displays a header 024 and a list of items 020, which consists of the links in the main navigational menu of the website. All the items in 020 are extracted from the webpage 008 and made available to the user. The graphical box 022 may or may not be visually contiguous with the scan button 013.

Similar to FIG. 3, in FIG. 4 we see the box 026 which is displayed when the user selects the ‘Address’ item from the box 018 in FIG. 2. The box 026 displays the header to signify the type of information displayed by the Scan method and a block of information 030 which displays the Address extracted from the site. The user may click the address item 030 to open a mapping application and display the address on the mapping application, within or outside the browser.

Similarly in FIG. 5, the box 032 is displayed when the user clicks the ‘Phone’ item in the box 018 of FIG. 2. The box 032 has a header 034 which identifies that the Phone numbers extracted from the website is being displayed. The phone numbers along with other similar information may be displayed in this box as shown at 036. The user may click on one of the numbers displayed to initiate a call.

Similarly, in FIG. 6, the box 038 is displayed when the user clicks the ‘Images’ item from the box 018 of FIG. 2. The header 040 indicates that the box lists the images extracted from the webpage. The list of images extracted 038 is displayed in the box with each item consisting of a snapshot or thumbnail view 042, of the image itself and a descriptive caption 044, both extracted from the page itself. The user can click one of the items on the list to get a larger view of the image or navigate directly to the image on the website.

Again, in FIG. 7 the box 047 is displayed when the user clicks the ‘Tables’ item in the box 018 of FIG. 2. The header 048 indicates that the box displays all tables extracted from the website. Below the header we see a list of tables extracted from the site, such as 046 with a thumbnail view or some symbolic FIG. 050 indicating the nature of the table next to it. The user can again select one of the tables here to display it in a larger view or navigate directly to it on the site.

FIG. 8 shows a box 050 which displays the forms extracted from the site. This box is displayed when the user clicks the ‘Forms’ item in the box 018 of FIG. 2. Below the header 052, we have the list of forms 054 extracted from the site. A small thumbnail view of the form or some symbol indicating the type of form 056 may be displayed next to it. The user can click one of these form items to navigate to the form on the site.

All drawings provided here are purely indicative in nature and are not meant to be limiting or exhaustive. The same concepts as presented as part of the current invention can be implemented with other interfaces and models while retaining the primary innovation disclosed here. Also, the terms ‘touch’, ‘click’, ‘select’ etc. have been used interchangeably here to imply the same action of the user selecting a particular element in the user interface for executing an action.

1. A system comprising:
a processor;
a computer readable non-transitory storage medium for tangibly storing thereon program logic for execution by the processor, the program logic comprising a method for extracting relevant information from a webpage and displaying it separately under a web browser based graphical user interface (‘UI’) element from where it can be easily accessed by the user.

2. A method of claim 1 for extracting relevant information elements based on their markup code, absolute and relative location in the webpage, their content, their surrounding elements, their descriptive information such as metadata and other relevant data items that might be available from the web page or from a different internal or network resource.

3. A method of claim 1, wherein the extracted information elements are organized and sorted into relevant categories and labeled according to their data types, so that images, text, forms, video, audio, and textual elements such as addresses, phone numbers and navigational elements such as menus and links are each categorized into their own separate category.

4. A method of claim 1, wherein the extracted, sorted and labeled information elements are presented to the user under a separate UI element within the web browser application's UI space; in one embodiment this separate UI element may be a button (‘Scan Button’) which when clicked, reveals a larger UI element (‘Scan Box’) which displays a list of options, which options when clicked lead the user directly or indirectly to the information elements originally extracted from the webpage.

5. A method of claim 4, wherein when the user clicks on one of the options in the Scan Box, the user is either navigated to the related information element on the webpage, or the information element is displayed within a newly created UI element.

6. A method of claim 5, wherein the information elements extracted from the webpage may be presented in their original form in the newly created UI element, or maybe reformatted and presented in a new, more user friendly format.

7. A method of claim 4, wherein the options displayed when the Scan Button is clicked may be items such as Home link, Menu List, Address, Phone Number, Map, Images, Videos, Information tables, Forms, among others.

8. A method of claim 7, wherein in one embodiment, when the user clicks the Home link, the user is navigated to the home page of the website; when the user clicks the Menu option, a list of menu items from the webpage is displayed in a new UI element; when the user clicks the Address option, the address from the webpage is displayed with the option to map it on a mapping application or within the browser on a mapping module; when the user clicks the phone option, the phone number from the webpage is displayed with the option to call it, when the Map option is clicked, the address from the web page is displayed in a map; when the Images option is clicked, the images from the web page are displayed in a gallery, possibly along with caption or other text; when Information Tables option is clicked, a list of tabular data elements from the web page is displayed, wherein when one specific table is selected, the user is navigated to that information table or the information table is displayed in a new UI element, in the original or reformatted format; when the Forms option is clicked, a list of form elements from the page is displayed, wherein when one option is selected the user is navigated to the form element in the web page or the form is displayed in a new UI elements in the original or reformatted format.

9. A method of claim 1, wherein the program logic which extracts and organizes the information elements of the webpage is a part of the web browser app itself, or an add-on program that receives information from the browser app and returns information to it or an application that runs within the browser itself.

10. A method of claim 1, wherein the program logic downloads the relevant information elements for certain webpages beforehand when possible, so when the user actually downloads the webpage, the relevant data elements will be made available to the user under the Scan Button without scanning the webpage and extracting information elements from it.

11. A method of claim 1, wherein the program logic provides information elements from other pages of the sites as well, not just the page downloaded; this may be accomplished by either downloading other pages of the site in the background without user initiation and scanning and extracting information elements from them or by accessing a network resource which provides the relevant information elements directly to the program logic, or by storing the information elements in a cache or other on-device storage, and retrieving the information elements when the same page or page from the same site is accessed again by the user.

12. A method of claim 1, wherein the developer(s) of the webpage and/or website include markup code within the webpage which is designed specifically for the said program logic, wherein when the page is downloaded the program logic reads this markup and directly accesses the relevant information elements from within the web page without running a full scan.
